(19) United States
(12) Patent Application Publication
(10) Pub. No.: US 2013/0185372 A1
(43) Pub. Date: Jul. 18, 2013

(54) MANAGEMENT OF USER EQUIPMENT SECURITY STATUS FOR PUBLIC WARNING SYSTEM

(71) Applicants: Alec Brusilovsky, Naperville, IL (US); Violeta Cakulev, Millburn, NJ (US)

(72) Inventors: Alec Brusilovsky, Naperville, IL (US); Violeta Cakulev, Millburn, NJ (US)

(73) Assignee: Alcatel-Lucent USA Inc., Murray Hill, NJ (US)

(21) Appl. No.: 13/351,053

(22) Filed: Jan. 16, 2012

(51) Int. Cl. G06F 15/16

(52) U.S. Cl. 709/207

(57) ABSTRACT

Techniques are disclosed for making one or more computing devices in a communication network aware of a public warning system security policy of at least one entity. In one example, a method comprises the following steps. An indicator of a public warning system security policy of at least one entity is associated with a control plane message. The control plane message, with the indicator of the public warning system security policy of the at least one entity, is generated by a first computing device of a communication network. The first computing device transmits the control plane message, with the indicator of the public warning system security policy of the at least one entity, to a second computing device of the communication network. The second computing device is made aware of the public warning system security policy of the at least one entity.

### CROSS REFERENCE TO RELATED APPLICATION

The present application is related to the U.S. patent application identified by attorney docket no. 811084-US-NP, entitled “Management of Public Keys for Verification of Public Warning Messages,” filed concurrently herewith, commonly assigned herewith, and incorporated by reference herein.

### FIELD

The field relates generally to communication networks, and more particularly to public warning systems associated with such communication networks.

### BACKGROUND

This section introduces aspects that may help facilitate a better understanding of the inventions. Accordingly, the statements of this section are to be read in this light and are not to be understood as admissions about what is prior art or what is not prior art.

The Third Generation Partnership Project (3GPP™) has published a technical specification, TS 22.268 version 11.3.0 (dated 2011-12), the disclosure of which is incorporated in its entirety by reference herein, describing general requirements for a Public Warning System (PWS) in a 3GPP™ communication network.

As disclosed in TS 22.268, there has been an interest to ensure that the public has the capability to receive timely and accurate alerts, warnings and critical information regarding disasters and other emergencies irrespective of what communications technologies they use. As has been learned from disasters such as earthquakes, tsunamis, hurricanes and wild fires; such a capability is essential to enable the public to take appropriate action to protect their families and themselves from serious injury, or loss of life or property. This is what the Public Warning System is intended to do.

### SUMMARY

Embodiments of the invention provide techniques for making one or more computing devices in a communication network aware of a public warning system security policy of at least one entity.

In one embodiment, a method comprises the following steps. An indicator of a public warning system security policy of at least one entity is associated with a control plane message. The control plane message, with the indicator of the public warning system security policy of the at least one entity, is generated by a first computing device of a communication network. The first computing device transmits the control plane message, with the indicator of the public warning system security policy of the at least one entity, to a second computing device of the communication network. The second computing device is made aware of the public warning system security policy of the at least one entity. In one example, the control plane message comprises a non-access stratum security mode command message.

In another embodiment, a method comprises the following steps. At a first computing device of a communication network, a control plane message generated by a second computing device of the communication network is received. The control plane message has associated therewith an indicator of a public warning system security policy of at least one entity. The first computing device then applies the public warning system security policy of the at least one entity.

Advantageously, illustrative embodiments of the invention substantially ensure that one or more computing devices, e.g., user equipment, in a communication network are made aware of a public warning system security policy of at least one entity.

These and other features and advantages of the present invention will become more apparent from the accompanying drawings and the following detailed description.

### BRIEF DESCRIPTION OF THE DRAWINGS

FIG. 1 is a diagram of a communication network according to an embodiment of the invention.

FIG. 2A is a diagram of a methodology for managing a public warning system security policy according to an embodiment of the invention.

FIG. 2B is a diagram of an example of a control plane message according to an embodiment of the invention.

FIG. 3 is a diagram of an architecture of a communication network suitable for implementing public warning system security policy management according to an embodiment of the invention.

### DETAILED DESCRIPTION

Illustrative embodiments of the invention will be described herein in the context of a public warning system (PWS) such as the PWS described in the above-referenced 3GPP™ TS 22.268. While embodiments of the invention may be well suited for implementation in accordance with TS 22.268, such as in a Long Term Evolution (LTE™) communication network, it is to be appreciated that alternative embodiments of the invention can be implemented in other computing environments and communication networks, and with public warning systems other than the ones mentioned in TS 22.268.

As used herein, a “policy” refers to one or more rules, directives, instructions, or the like, as well as combinations thereof.

As used herein, an “entity,” with respect to a security policy of a public warning system, refers to a private or public agency or authority that promulgates the security policy associated with the public warning system and/or controls the dissemination of the security policy associated with the public warning system.

As used herein, a “control plane” refers to a functional layer of a communication network protocol stack whose functions include one or more of discovery, routing, path computation, signaling, or the like, with regard to computing devices in the communication network. Thus, a “control plane message” is a message that is generated and/or transmitted as part of the control plane of a protocol stack associated with a communication network in order to effectuate one or more of the above-mentioned control plane functions.

As used herein, a “network operator” (or “telecom operator”) refers to a company that owns and operates a communication network (or parts thereof) and thus provides services to subscribers. Examples of network operators include, but are not limited to, AT&T™ and Verizon™.

As mentioned above, there has been an increasing desire and/or need to implement a PWS in accordance with communication networks such as, for example, mobile cellular networks. Thus, it is realized that user equipment (UE, or a mobile station (MS)) of such a network should have the capability of receiving PWS notifications within given notification areas through the mobile cellular network. The UE should also know what to do with such warnings including how to process and display any received warnings so as to alert the person or persons who possess the UE. Examples of a UE may include, but are not limited to, a mobile telephone, a smart phone, a portable computer, a tablet, a wireless email device, a personal digital assistant (PDA) or some other mobile computing device.

One example of a PWS, as described in TS 22.268, is the Commercial Mobile Alert System (CMAS) which delivers warning notification messages provided by warning notification providers to CMAS-capable UEs. The CMAS includes three different classes of warning notifications (i.e., Presidential, Imminent Threat, and Child Abduction Emergency). Another example of a PWS described in TS 22.268 is the Earthquake and Tsunami Warning System which delivers to the UEs warning notification messages specific to natural disasters, such as earthquakes and tsunamis, provided by warning notification providers.

In such PWSs, the UEs are capable of receiving primary and secondary warning notification messages through the communication network to which they are attached. It is understood that a primary warning notification message (or primary PWS message) is one that generally conveys a small amount of warning data (relative to the secondary warning notification message, for example, a few bytes) in an expedited manner so as to quickly convey the imminent occurrence of the subject event (e.g., natural disaster). A secondary warning notification message (or secondary PWS message) is one that generally conveys a large amount of warning data (relative to the primary warning notification message) to provide text and/or audio to instruct someone what to do and where to go in the emergency, as well as graphical data including maps to evacuation sites and time tables for food distribution, and the like.

Furthermore, TS 22.268 lays out some high level general requirements for warning notification delivery:

(i) The PWS shall be able to broadcast warning notifications to multiple users simultaneously with no acknowledgement required.

(ii) The PWS shall be able to support concurrent broadcast of multiple warning notifications.

(iii) Warning notifications shall be broadcast to a notification area which is based on the geographical information as specified by the warning notification provider.

(iv) The PWS-capable UEs (PWS-UE) in idle mode shall be capable of receiving broadcasted warning notifications.

(v) The PWS shall only be required to broadcast warning notifications in languages as prescribed by regulatory requirements.

(vi) Warning notifications are processed by the PWS on a first in, first out basis, subject to regulatory requirements.

(vii) The reception and presentation of warning notifications to the user shall not pre-empt an active voice or data session.

(viii) Warning notifications shall be limited to those emergencies where life or property is at imminent risk, and some responsive action should be taken. This requirement does not prohibit the use of the operator's network (i.e., broadcast technology) implemented for warning notifications to be used for commercial services.

TS 22.268 also lays out some high level general requirements for warning notification content:

(i) The PWS shall not modify or translate the warning notification content specified by the warning notification provider.

(ii) It is expected that warning notifications would likely include the following five elements: (1) event description; (2) area affected; (3) recommended action; (4) expiration time (with time zone); and (5) sending agency.

(iii) Additional content elements may be present, based on regulatory requirements.

(iv) There is a concern that uniform resource locators (URLs) or telephone numbers in a warning notification could exacerbate wireless network congestion at a time when network traffic is already dramatically increasing as individuals contact police, fire, and rescue personnel, as well as their loved ones. Therefore, warning notifications according to TS 22.268 should not contain anything that would drive immediate and debilitating traffic loads into the Public Land Mobile Network (PLMN) such as URLs or dial-able numbers.

Further, TS 22.268 lays out some high level general requirements for security associated with warning notification content:

(i) The PWS shall only broadcast warning notifications that come from an authenticated and authorized source.

(ii) The integrity of the warning notification shall be protected.

(iii) The PWS shall protect against false warning notification messages.

Thus, it is realized that one important requirement for the PWS is the desire/need to verify the authenticity of the primary and the secondary PWS messages received over the communication network. Such verification is possible by protecting the integrity of the PWS messages by a private key (PrK) of the source of the PWS messages. The source may, for example, be a government or private agency tasked in a given geographic or municipal locale to generate and disseminate PWS messages.

Currently, some locales are required to implement PWS security (e.g., European Union countries), while some locales are not required to do so (e.g., United States mobile network operators). In addition, there are different regional requirements for providing PWS messages to UEs which are inbound roaming UEs (as is known, roaming UEs are UEs that are not operating in their home network but rather are operating in a visiting network). Also, while newer or upgraded UEs have PWS security capabilities, the older and non-upgradable UEs do not. Furthermore, some countries require unauthenticated UEs to be served PWS messages.

Therefore, it is further realized that it is important to develop one or more procedures which will communicate the policy regarding PWS security for a given entity (e.g., a serving network or SN) to either roaming or home-based UEs. Such a procedure(s) also should be transparent to the older/non-upgradable UEs as well as to the unauthenticated UEs.

A current solution includes provisioning of a static PLMN list in the UEs. This list can be either “white” (listing authorized sources) or “black” (listing unauthorized sources). Depending on the PLMN list setting, capabilities of the UE, and the serving PLMN (i.e., serving network or SN), the UE would either use security for PWS messages or not.

Embodiments of the invention provide a much more flexible approach to the distribution of PWS security policies. As will be explained in detail below, one embodiment of the invention associates an indicator of a PWS security policy of at least one entity (e.g., public or private agency or authority) with a control plane message generated by a computing device of the communication network (e.g., a network node). The computing device transmits the control plane message, with the indicator of the public warning system security policy of the at least one entity, to another computing device of the communication network (e.g., a UE). The UE is thus made aware of the public warning system security policy of the at least one entity. In the example below, the control plane message comprises a non-access stratum (NAS) security mode command (SMC) message. It is to be understood that by the phrase “associates an indicator of a PWS security policy of at least one entity with a control plane message,” this means that the indicator is at least one of inserted in, attached to, appended to, merged with, and combined with (or the like) the control plane message (in this example, the NAS SMC message).

Advantageously, such an embodiment is less expensive to manage for PLMNs. Also, such an embodiment allows flexible PWS security on the UEs depending on the PWS security policy, UE capabilities, as well as UE authentication and roaming status.

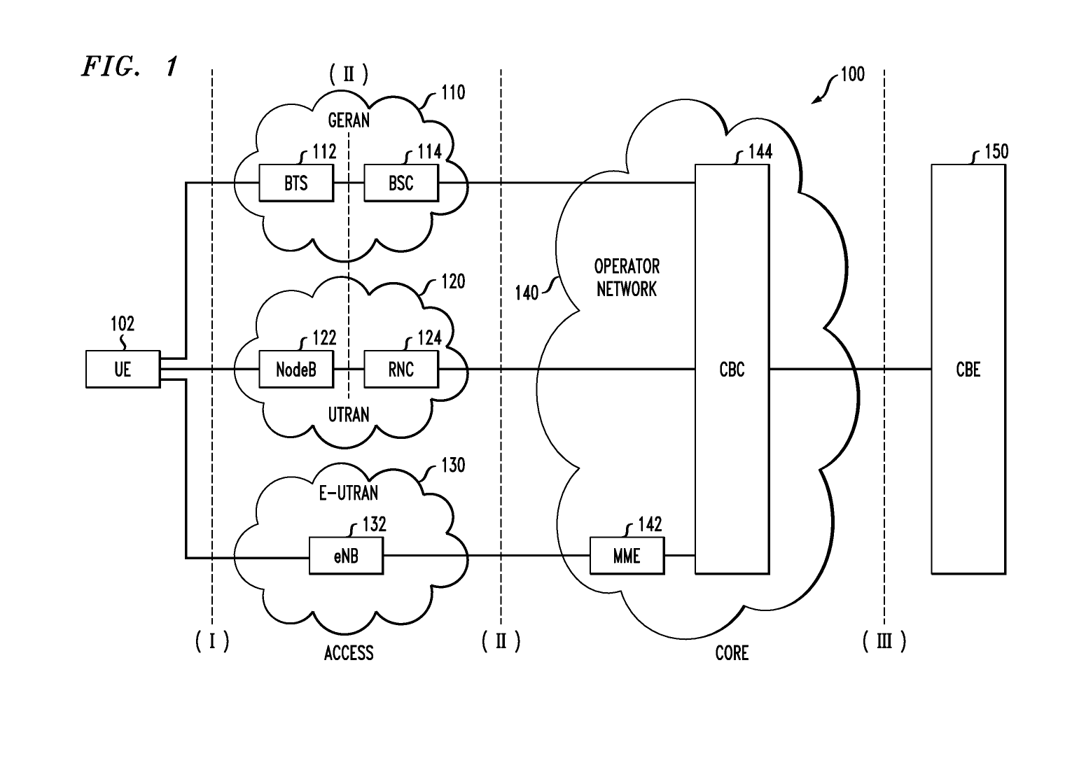

FIG. 1 shows a communication network 100 according to an embodiment of the invention. As shown, a UE 102 accesses communication network 100 via one of access networks 110, 120, and 130. Only one UE is shown for the sake of simplicity, however, it is understood that more than one UE can access communication network 100. It is also to be understood that UE 102 may be configured to be able to communicate with all three access networks shown in FIG. 1.

Access network 110 is a GSM Edge Radio Access Network (GERAN, where GSM refers to a Global System for Mobile communications) and includes a base transceiver station (BTS) 112 and a base station controller (BSC) 114, as is known in the art. Access network 120 is a UMTS Terrestrial Radio Access Network (UTRAN, where UMTS refers to a Universal Mobile Telecommunications System) and includes a base station (NodeB) 122 and a radio network controller (RNC) 124, as is known in the art. Access network 130 is an Evolved UTRAN network (E-UTRAN) and includes a base station (eNB) 132, as is known in the art. It is understood that access networks 110, 120, and 130 can have multiple ones of the network elements shown, as well as other network elements not shown; however, for simplicity, only one of the above-mentioned network elements are shown in each access network.

Communication network 100, as depicted in FIG. 1, also includes a core network 140 which includes a mobility management entity (MME) 142 and a cell broadcast center 144, as is known in the art. Other network elements can be part of the core network.

Further, a cell broadcast entity (CBE) 150 is part of communication network 100. CBC 144 and CBE 150 are part of the PWS infrastructure. “Cell broadcast” refers to the ability to broadcast one or more messages to mobile stations (UEs) in a “cell” (as used in a mobile cellular network). In the case of a PWS, the messages are the warning notification messages described above.

CBE 150 may represent, for example, the entity that promulgates the security policy associated with the PWS and/or controls the dissemination of a security policy associated with the PWS, as well as the entity that is the source of the warning notification messages. CBC 144 is the network element that then distributes the messages and security policy. More than one security policy can be distributed. However, in the case of the E-UTRAN access network 130, MME 142 receives these messages and policies from CBC 144 and distributes them to the E-UTRAN access network 130 which then forwards them to the UEs.

The protocols between CBC 144 and network elements of the access networks are defined in 3GPP™ TS 48.049, TS 25.419 and TS 23.401, the disclosures of which are incorporated by reference herein.

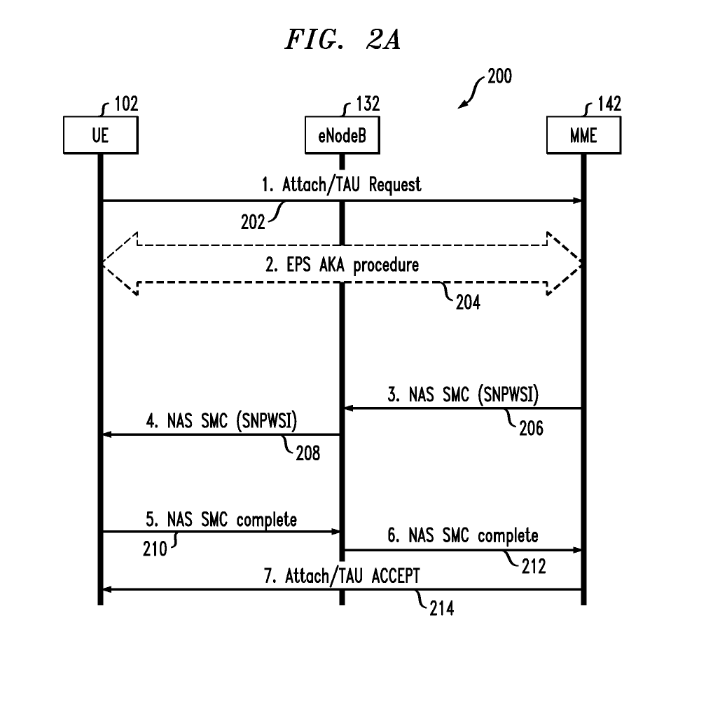

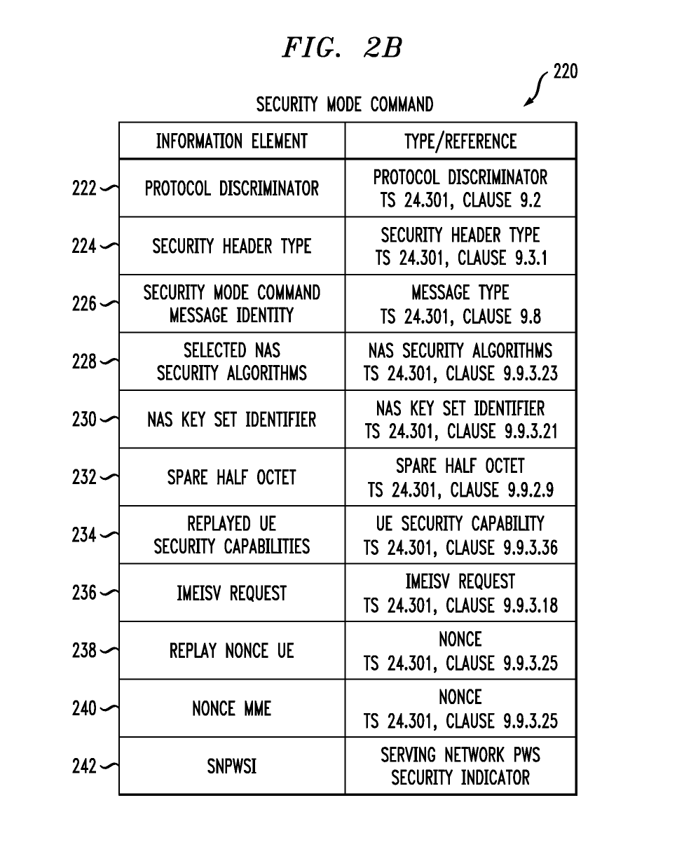

FIG. 2A shows a methodology 200 for managing a public warning system security policy according to an embodiment of the invention. Methodology 200 illustratively shows the association (e.g., inserting, attaching, appending, merging, combining, or the like) of an indicator of a PWS security policy of a serving network or an SNPWSI (in this case, core network 140 is the serving network) with a control plane message (in this case, a NAS SMC message) in the context of the E-UTRAN access network 130. Methodologies for access networks 110 and 120, as well as other access networks, may be the same or similar.

As shown, in an initial attach or TAU (tracking area update) procedure depicted as step 202, UE 102 sends the initial attach request to MME 142 through eNB 132. EPS Authentication and Key Agreement (AKA) procedure can take place between UE 102 and MME 142 in step 204, as shown. EPS stands for Evolved Packet System which is the name given to the radio network of the E-UTRAN.

In step 206, the MME 142 associates the SNPWSI with the NAS SMC message and transmits the message with the indicator to eNB 132, which then forwards the message with the indicator to UE 102 in step 208. It is to be appreciated that the NAS SMC message is typically used by the MME to initialize an NAS signaling security context between the UE and the MME. The NAS SMC message can also be used to change the NAS security algorithms for a current EPS security context in use.

Advantageously, embodiments of the invention are utilizing the NAS SMC message (more generally, a control plane message) to convey the PWS security policy of the CBE to the UEs that are operating in a given notification area. The UEs will then know what security policy is in force. More specifically, upon receiving the NAS SMC message in step 208, UE 102 saves the SNPWSI sent from MME 142 via the NAS SMC message. UE 102 now knows the serving network policy regarding PWS security, and can modify its processing of PWS messages in response to such PWS security policy.

In steps 210 and 212, UE 102 sends an NAS SMC complete message back to MME 142 through eNB 132. The NAS SMC complete message typically includes the UE's IMEISV (International Mobile Equipment Identity Software Version). Then, in step 214, UE 102 is notified of the acceptance of the attach or TAU request by MME 142.

FIG. 2B is a diagram of an example of a control plane message according to an embodiment of the invention. More particularly, FIG. 2B shows a message format 220 for the NAS SMC message generated and transmitted by the MME 142 (in step 206 of FIG. 2A) and forwarded to UE 102 (in step 208 of FIG. 2A). As shown, content elements 222 through 240 (i.e., Protocol discriminator 222, Security header type 224, Security mode command message identity 226, Selected NAS security algorithms 228, NAS key set identifier 230, Spare half octet 232, Relayed UE security capabilities 234, IMEISV request 236, Replayed nonce_{UE} 238, and Nonce_{MME} 240) are described in 3GPP™ TS 24.301, the disclosure of which is incorporated by reference herein. The additional content added to (more generally, associated with) the message is SNPWSI 242.

It is to be appreciated that SNPWSI 242 can, for example, in alternative embodiments, be part of the spare half octet 232 or can be added to the SMC payload. Further, in one embodiment, SNPWSI 242 can be one logic bit in length, where a first logic level (e.g., logic level “1”) means that security is to be applied, and a second logic level (e.g., logic level “0”) means that no security is to be applied. When “security is applied” (e.g., SNPWSI=1), this means, for example, that the UE will attempt to authenticate the PWS message source (e.g., check PWS message integrity and signature), and prevent PWS message replay if configured to do so. When “no security is applied” (e.g., SNPWSI=0), this means, for example, that the UE will not attempt to authenticate the PWS message source nor prevent PWS message replay.

It is to be understood that, in alternative embodiments, SNPWSI 242 can be larger than one bit (and thus provide additional information regarding the PWS security policy that is to be applied) depending on the downlink air interface bandwidth.

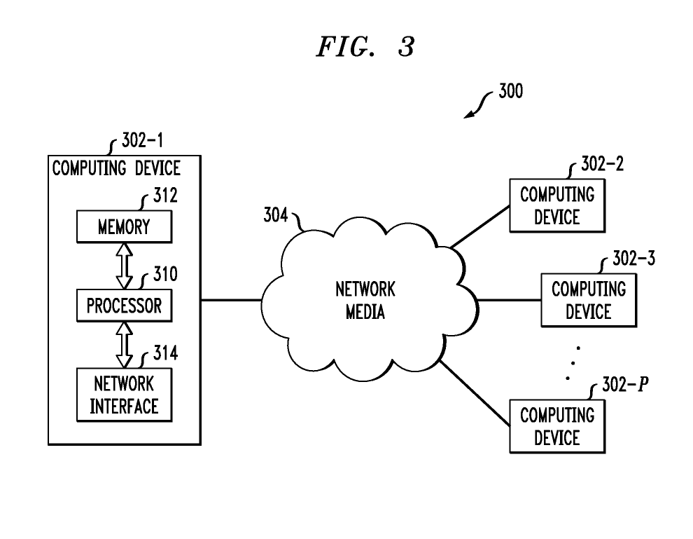

Lastly, FIG. 3 shows an architecture of a communication network 300 suitable for implementing PWS security policy management according to an embodiment of the invention.

As shown, computing devices 302-1, 302-2, 302-3, . . . , 302-P are operatively coupled via communication network media 304. The network media can include any network media across which the computing devices are capable of communicating including, for example, a wireless medium and/or a wired medium. By way of example, the network media can carry IP (Internet Protocol) packets end to end and may involve any of the communication networks mentioned above. However, the invention is not limited to any particular type of network medium.

It is to be understood that the computing devices shown in FIG. 3 represent the components described above in the context of FIGS. 1 and 2A, i.e., UE 102 and the various network elements shown, BTS 112, BSC 114, NodeB 122, RNC 124, eNB 132, MME 142, CBC 144, and CBE 150. Two or more components in FIG. 1 can also share a computing device shown in FIG. 3.

As would be readily apparent to one of ordinary skill in the art, the computing devices in FIG. 3 may be implemented as programmed computers operating under control of computer program code. The computer program code would be stored in a computer (or processor) readable storage medium (e.g., a memory) and the code would be executed by a processor of the computer. Given this disclosure of the invention, one skilled in the art could readily produce appropriate computer program code in order to implement the methodologies and protocols described herein.

Nonetheless, FIG. 3 generally illustrates an exemplary architecture for each computing device communicating over the network media. As shown, computing device 302-1 comprises processor 310, memory 312, and network interface 314. Thus, each computing device in FIG. 3 may have the same or a similar computing architecture.

It should be understood that the term “processor” as used herein is intended to include one or more processing devices, including a signal processor, a microprocessor, a microcontroller, an application-specific integrated circuit (ASIC), a field programmable gate array (FPGA) or other type of processing circuitry, as well as portions or combinations of such circuitry elements. Also, the term “memory” as used herein is intended to include electronic memory associated with a processor, such as random access memory (RAM), read-only memory (ROM) or other types of memory, in any combination. Further, the phrase “network interface” as used herein is intended to include any circuitry or devices used to interface the computing device with the network and other network components. Such circuitry may comprise conventional transceivers of a type well known in the art.

Accordingly, software instructions or code for performing the methodologies and protocols described herein may be stored in one or more of the associated memory devices, e.g., ROM, fixed or removable memory, and, when ready to be utilized, loaded into RAM and executed by the processor. That is, each computing device shown in FIG. 3 may be individually programmed to perform their respective steps of the methodologies and protocols depicted in FIGS. 1 and 2A.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
associating an indicator of a public warning system security policy of at least one entity with a control plane message generated by a first computing device of a communication network; and
transmitting the control plane message, with the associated indicator of the public warning system security policy of the at least one entity, from the first computing device to a second computing device of the communication network, such that the second computing device is made aware of the public warning system security policy of the at least one entity.

2. The method of claim 1, wherein the at least one entity comprises at least one of a public entity and a private entity that controls the public warning system security policy.

3. The method of claim 1, wherein the at least one entity comprises a cell broadcast entity.

4. The method of claim 1, wherein the control plane message comprises a non-access stratum security mode command message.

5. The method of claim 4, wherein the first computing device comprises a mobility management entity.

6. The method of claim 5, wherein the second computing device comprises user equipment.

7. The method of claim 6, wherein the user equipment sends an attach request to the mobility management entity.

8. The method of claim 7, wherein the mobility management entity associates the indicator of the public warning system security policy with the non-access stratum security mode command message, and forwards the message with the indicator to the user equipment.

9. The method of claim 8, wherein the user equipment forwards a non-access stratum security mode command complete message to the mobility management entity in response to the non-access stratum security mode command message.

10. The method of claim 9, wherein the mobility management entity notifies the user equipment of the acceptance of the attach request.

11. The method of claim 7, wherein the user equipment and the mobility management entity perform an authentication procedure.

12. An article of manufacture comprising a processor-readable storage medium storing one or more software programs which when executed by a processor associated with the first computing device perform the steps of the method of claim 1.

13. A method, comprising:
receiving, at a first computing device of a communication network, a control plane message generated by a second computing device of the communication network, the control plane message having associated therewith an indicator of a public warning system security policy of at least one entity; and
applying, at the first computing device, the public warning system security policy of the at least one entity.

14. An article of manufacture comprising a processor-readable storage medium storing one or more software programs which when executed by a processor associated with the first computing device perform the steps of the method of claim 13.

15. An apparatus, comprising:
a memory; and
a processor operatively coupled to the memory to form a first computing device of a communication network, which is configured to:
associate an indicator of a public warning system security policy of at least one entity with a control plane message generated by the first computing device; and
transmit the control plane message, with the associated indicator of the public warning system security policy of the at least one entity, from the first computing device to a second computing device of the communication network, such that the second computing device is made aware of the public warning system security policy of the at least one entity.

16. The apparatus of claim 15, wherein the control plane message comprises a non-access stratum security mode command message.

17. The apparatus of claim 15, wherein the first computing device comprises a mobility management entity.

18. The apparatus of claim 15, wherein the second computing device comprises user equipment.

19. The apparatus of claim 15, wherein the at least one entity comprises a cell broadcast entity.

20. An apparatus, comprising:
a memory; and
a processor operatively coupled to the memory to form a first computing device of a communication network, which is configured to:
receive, at the first computing device, a control plane message generated by a second computing device of the communication network, the control plane message having associated therewith an indicator of a public warning system security policy of at least one entity; and
apply, at the first computing device, the public warning system security policy of the at least one entity.
